(19) United States
(12) Patent Application Publication
(10) Pub. No.: US 2014/0331710 A1
(43) Pub. Date: Nov. 13, 2014

(54) COMPACT HVAC SYSTEM FOR A MOTOR VEHICLE

(71) Applicant: Halla Visteon Climate Control Corp., Daejeon (KR)

(72) Inventors: Jörn Fröhling, Koln (DE); Marc Graaf, Krefeld (DE); Felix Girmscheid, Koln (DE); Gerald Richter, Aachen (DE); Gerd Vondahlen, Gangelt (DE); Florian Wieschollek, Hurth (DE); Tobias Haas, Koln (DE)

(21) Appl. No.: 14/340,609

(22) Filed: Jul. 25, 2014

Related U.S. Application Data
(62) Division of application No. 12/850,216, filed on Aug. 4, 2010.

(30) Foreign Application Priority Data
Aug. 13, 2009 (DE) 10 2009 028 522.9

(51) Int. Cl. B60H 1/00

(52) U.S. Cl. CPC B60H 1/00021
USPC 62/428

(57) ABSTRACT

The invention relates to a compact vehicle HVAC system including an evaporator unit, a condenser unit, and a component unit, as well as a refrigerant circuit. The evaporator unit and the condenser unit each are provided with air-passed heat exchangers and a fan in a casing. Further circuit components are displaced within the component unit. The casings of the evaporator unit, the condenser unit, and the component unit advantageously establish a connected compact casing arrangement. The heat exchangers are displaced within the compact casing arrangement. The refrigerant circuit is established for a combined refrigeration plant and heat pump operation as well as an afterheating operation, whereby in the afterheating operational mode the heating power of the afterheater established as condenser/gas cooler and the cooling power of the evaporator are controllable independently of each other.

### CROSS-REFERENCE TO RELATED APPLICATION

This application is a Divisional patent application of U.S. patent application Ser. No. 12/850,216 filed Aug. 4, 2010, which claims priority to German Patent Application Serial Number DE 10 2009 028 522.9 filed Aug. 13, 2009, the entire disclosures of which are hereby incorporated herein by reference.

### FIELD OF THE INVENTION

The invention relates to a compact vehicle HVAC system including different units. The units establish a connected, compact casing arrangement. The compact vehicle HVAC system is provided for the combined refrigeration plant and heat pump operation as well as an afterheating operation for heating, cooling and dehumidifying of the air to be conditioned for the passenger compartment. Also, the invention relates to a process for operating the HVAC system.

### BACKGROUND OF THE INVENTION

Generally, in recent motor vehicles, it is demanded of the technical components because of their great number that the volume of the single components and the placement relative to each other be optimized in order to realize the desired functional variety by placing all components in the limited space of the motor vehicle. Therefore, for example, high-volume components for air conditioning as known from stationary air conditioning units cannot be used because of the limited available space.

For a long time, HVAC systems for motor vehicles are state-of-the art. Traditional vehicle HVAC systems include various single components such as the condenser usually placed at the vehicle front end, the compressor connected to and driven by the vehicle engine, the evaporator located in the passenger compartment, and hoses and connections. The HVAC system conditions the air that is then passed into the passenger compartment. Usually, the engine of the vehicle is used to drive the compressor by coupling in mechanical energy for driving the compressor shaft. The radiator fan and blower are fed from the 12-volt vehicle electric power supply.

Traditionally, the components of the unit are individually supplied to the vehicle manufacturer and then mounted. Due to the number of the components, different assembly steps are necessary relating to a plurality of connections, which makes the assembly expensive. In addition, the connections to be made during assembly are potential leakage points that could only be corrected with very much time and cost consumed. Also, coolant is only filled into the HVAC system after all components being parts of the cooling circuit have been installed. That further increases the installation effort during assembly of the vehicle.

Known systems with coolant-air heat exchangers that receive the heating power from the cooling circuit of an efficient internal combustion engine of the vehicle drive no longer achieve the level demanded for the passenger compartment to be heated up to a comfortable temperature under the conditions of low ambient temperatures such as, for example, −10° C. The same applies for systems in vehicles that are equipped with a hybrid drive. In the future, for these vehicles efficient, additional heating concepts will have to be used.

Glycol-air heat pumps also use the coolant of the internal combustion engine as heat source. Heat is removed from the coolant. Consequently, the internal combustion engine will be operated at lower temperatures for a longer time, which negatively affects the exhaust gas emissions and fuel consumption. Due to intermittent operation of the internal combustion engine in hybrid vehicles, a sufficiently high coolant temperature is not reached during longer drives. Consequently, the on/off-operation of the internal combustion engine is interrupted at lower ambient temperatures. The internal combustion engine will not be switched off.

There is a trend to completely electrify the drive such as vehicles driven by batteries or fuel cells. Here, waste heat of the internal combustion engine is not available as a potential heat source for heating the air.

Today, the useful energy storable in the battery of the vehicle is lower compared with the energy storable in form of liquid fuel within the fuel tank. For that reason, the power needed for air conditioning the passenger compartment of an electrically driven vehicle has an essential influence on the cruise range of the vehicle.

From DE 10 2007 046 663 A1, a premounted system of an HVAC system with a z-shaped fan-heat exchanger arrangement and a prefilled refrigerant circuit is known. The system is an auxiliary air conditioning unit that can be operated independently of the vehicle motor and is provided with a closed refrigerant circuit with evaporator, compressor and condenser, which are flow-connected to each other, as well as a fuel-driven coolant heater and a radiator. The compressor is supplied from a vehicle-engine independent energy source such as a generating set, a battery, or external electrical power. The fan, for example, is driven by a brushless electric motor. The closed circuit enables filling the refrigerant before mounting the auxiliary air conditioning unit into a vehicle.

It is disadvantageous that, for example, the coolant heater as auxiliary fuel heater delivers its heat power to the engine cooling circuit, which finally transmits the heat over the radiator to the air to be conditioned, hence reaching insufficient dynamics and low efficiency.

In DE 10 2006 012 749 A1, a motor vehicle HVAC system, particularly for parking air conditioning, is described provided with an electrically driven compressor, an evaporator, and a condenser, each with an electrically driven fan. The electrical drives enable operating the components independently of the vehicle engine, while supplied by a generating set, battery, or fuel cell.

The HVAC system is designed for drawing air from the passenger compartment and/or the environment as a compact system placed in a casing, disadvantageously not provided with a heating function.

Air-air heat pumps of the state-of-the-art that are designed for combined refrigeration plant and heat pump operation, hence, for the heating operation too, remove heat from the ambient air. Disadvantageously, the cooling of the ambient air can lead to ice build-up at the gas cooler, which is operated as evaporator in the heat pump operational mode. Ice build-up at the heat transmission surfaces can be avoided by specifically controlling the heat pump. But the usable heating power of the heat pump is reduced. With ice build-up being permitted, the heat pump can actively be defrosted by short-time operation of the refrigerant circuit as refrigeration plant. But also, this operational mode reduces the mean heating capacity of the heat pump.

Heat pump systems where power is transmitted between the refrigerant and air frequently cannot at the same time dehumidify and heat the air supplied to the vehicle. This results in that the air conditioning unit of a vehicle cannot be operated with recirculated air at low ambient temperatures. In recirculation mode, the air of the passenger compartment recirculates. Due to the failing dehumidification function, the remaining humidity of the air and the water delivered by the passengers in form of vapor would lead to fogged window glasses.

In conventional HVAC systems, at ambient temperatures above 20° C., after having reached thermal comfort, the air supplied to the passenger compartment is cooled down to approximately 3° C. to 10° C., thereby dehumidified and then heated with low heating power to the desired supply air temperature. Constituent of the thermal comfort is, for example, a required temperature of approximately 20° C. to 25° C. in the passenger compartment.

For example, for electrically driven vehicles without utilizing motor waste heat, without waste heat of electrical aggregates, or without an additional resistance heating (PTC), there is no possibility to afterheat with low heating power in refrigeration or dehumidifying operational mode of the HVAC system.

In DE 10 2006 026 359 A1, an HVAC system for a combined refrigeration plant and heat pump operation is described. The disclosed heat pump system consists of a primary circuit and a secondary passage divided into different sections, whereby the primary circuit includes the components known of a classical compression refrigerating machine such as a compressor, two heat exchangers, and a throttling member. The secondary passage is provided first with an additional heat exchanger and a throttling member located downstream, and second an additional connecting line. Disadvantageously, the HVAC system enables afterheating only in the heat pump operational mode. In addition, the heating power delivered to the air in the additional heat exchanger of the secondary passage is always higher than the refrigeration power taken in the heat exchanger, established as evaporator, of the primary circuit.

In a reheating or afterheating operation, respectively, the air supplied to the passenger compartment is cooled and thereby dehumidified, the dehumidified air is then slowly heated. In this operational mode, the required afterheating power is lower than the refrigeration power required for cooling and dehumidifying the air. This operational mode cannot be performed using the HVAC system disclosed in DE 10 2006 026 359 A1.

The required temperature of the air supplied to the passenger compartment is therefore only providable by increasing the evaporator temperature level, which disadvantageously leads to a lower dehumidification capacity and thus, reduced comfort.

Another important disadvantage of traditional refrigerant circuits of HVAC systems in refrigeration plant operational mode is that the refrigerant on the high pressure side downstream of the gas cooler or condenser cannot be cooled down to a temperature below the ambient temperature. Further cooling of the refrigerant before expansion would, particularly at high ambient temperatures, result in a considerable increase in capacity and efficiency. In the prior art, an internal heat exchanger is used to counteract this disadvantage. The heat delivered to cool the refrigerant to high pressure level, however, is transmitted to the low pressure side and re-supplied to the gaseous refrigerant before compression, which reduces the suction density of the refrigerant at the compressor and thus, counteracts the increase in capacity. In addition, the higher suction temperatures cause higher compression final temperatures, which negatively affect the energy efficiency and service life of the compressor.

### SUMMARY OF THE INVENTION

This invention relates to developing a compact, pre-assemblable HVAC system with heating functionality, particularly for use in motor vehicles with an insufficient heat source from the drive, in such a way that the refrigerant circuit is established hermetically tight and wherein an arrangement of the HVAC system outside the engine compartment of the vehicle is possible.

Further, the invention relates to developing a refrigerant circuit for the combined refrigeration plant and heat pump operation as well as the afterheating operation for heating, cooling, and dehumidifying the air to be conditioned for the passenger compartment in a constructively simple manner and to provide a process to operate the refrigerant circuit that enables improving the controllability. The unit with the refrigerant circuit is designed to enable the operation with a high refrigeration output at lower heating capacity.

According to the invention, the shortcomings of the prior art are solved by a compact vehicle HVAC system comprising an evaporator unit, a condenser unit and a component unit, each including components of a refrigerant circuit. The refrigerant circuit is provided for a combined refrigeration plant and heat pump operation as well as afterheating operation.

According to the concept of the invention, the evaporator unit comprises two air-passed heat exchangers and a fan within a casing. One of the heat exchangers is established to be an evaporator functioning to cool and/or dehumidify the air to be conditioned. The second heat exchanger is an afterheater functioning to reheat the cooled air to a temperature desired by the passenger, before the air is then supplied to the passenger compartment.

The compact vehicle HVAC system further includes a condenser unit that is provided with an air-passed heat exchanger and a fan also within a casing, and a component unit in which other circuit components are placed.

The casings of the evaporator unit, the condenser unit, and the component unit advantageously establish a connected compact casing arrangement. According to the invention, the air-passed heat exchangers all are displaced within the compact casing arrangement.

Alternatively, the evaporator unit and the component unit are established integrated as a common component. The casings of the evaporator unit and the component unit are either pre-assembled, i.e. connected to a common casing, or the evaporator unit and the component unit have a common casing. The air passing the evaporator unit is led through the heat exchangers. The circuit components not applied by the air are separated from the air flow by a partition wall.

Particularly advantageous is the combination of evaporator unit, component unit, and condenser unit, that is the integration of the units' casings to a compact system as then all circuit components of the refrigerant circuit are displaced within the casing arrangement. The evaporator unit, the condenser unit, and the component unit either are provided as individual components and established such that they are integratable to the compact casing arrangement as a multi-part casing, or they are integrated within a one-part casing that accommodates all components.

The HVAC system with the refrigerant circuit integrated is completely pre-assemblable and installable as compact unit during the assembly of the vehicle. In addition, the refrigerant circuit is already fillable before being mounted into the motor vehicle, which considerably makes easier the final assembly of the vehicle.

Further, the quality inspection of the HVAC system is made easier. Afterwork following the mounting of the HVAC system into the vehicle is not necessary, because the system can be checked already before mounting it into the vehicle, such as pressure- and leakage-checked.

The evaporator unit and the condenser unit are preferably established each as a flow channel for the air. The fans of the units draw the air by means of a radial blower delivering the air through the channel and the heat exchangers displaced in the channel. Each flow channel is advantageously suppliable with fresh air from the environment, recirculated air from the passenger compartment, or a mixture of fresh and recirculated air. The compressor of the refrigerant circuit is located in the flow channel of the condenser unit so that the compressor is cooled by the air flowing around it. Alternatively to the location within the condenser unit, the compressor is also locatable within the component unit.

The flow channels of the evaporator unit and the condenser unit are displaced such that the direction of flow of the air leaving the evaporator unit and the direction of flow of the air leaving the condenser unit are oriented parallel to each other. According to an embodiment of the invention, the flow channels are, in addition, oriented such that the air leaves the channels along a common axis opposite to each other. The directions of flow are offset to each other by 180°.

The fans of the evaporator unit and the condenser unit for delivering the air may be displaced laterally next to the flow channels, at opposite sides of the casing arrangement. The fans may be established as radial blowers drawing the air from the lower or upper side of the casing arrangement.

Advantageously, the compressor of the HVAC system according to the invention is electrically driven so that a hermetic compressor can be used. Associated with the compact design of the HVAC system within a casing arrangement and hence, the connections between the circuit components not requiring dynamic seals, the refrigerant circuit is technically leak-tight. No relative motions between the circuit components have to be compensated.

Further, due to the electric drive, the compact vehicle HVAC system can be placed at any position in the vehicle such as below the passenger compartment, at the front wall of the passenger compartment, or in the trunk of the vehicle. The evaporator unit, the condenser unit and the component unit are integrated into the walls of the passenger compartment, the walls of the trunk or into the vehicle bottom. When integrated into the vehicle bottom, a slim column-like structure results that has fans arranged, in relation to the longitudinal extension, centrally and on both sides, whereby both air flows enter the system at the sides over the fans and leave the system each at the ends of the columns. When displaced in the vehicle bottom, the HVAC system is horizontally oriented having a column-like structure.

Summarizing, it can be stated that the essential advantage of the vehicle HVAC system is the modular design which also enables the modules to be arranged in a compact way. The modular design is advantageous when the HVAC system is assembled in the vehicle, filled, and inspected. Based on the modular design, the modules can advantageously be freely displaced relative to each other dependent on the space available in the vehicle.

The problem of further development of a refrigerant circuit for heating, cooling and dehumidifying the air to be conditioned for the passenger compartment is solved by a refrigerant circuit for the combined refrigeration plant and heat pump operation as well as the afterheating operation.

The refrigerant circuit comprises a primary circuit and a secondary branch that includes two flow paths.

The primary circuit which is provided with a compressor, a first heat exchanger for transferring heat between the refrigerant and the environment, an expansion member, and a second heat exchanger for supplying heat from the air to be conditioned of the passenger compartment to the refrigerant, has components of a conventional refrigerant circuit of an HVAC system. The heat exchangers are passable bidirectionally at the refrigerant side, the expansion member is established with two flow paths passable by the refrigerant in opposite directions.

The secondary branch has two flow paths. The first flow path that extends originating from a tap positioned between the compressor and the first heat exchanger of the primary circuit to an entering point or tap positioned between the second heat exchanger and the compressor is provided with a heat exchanger for transferring heat from the refrigerant to the air to be conditioned of the passenger compartment and an expansion member following downstream. The second flow path connects a tap positioned between the compressor and the first heat exchanger of the primary circuit to an entering point or tap positioned between the second heat exchanger and the compressor.

According to the concept of the invention, a valve is displaced between the tap of the first flow path and the tap of the second flow path.

According to an embodiment of the invention, the valve displaced between the tap of the first flow path and the tap of the second flow path is established as shut-off valve. The shut-off valve is advantageously controllable steplessly between the states OPEN and SHUT-OFF.

The first heat exchanger of the primary circuit, which corresponds to the heat exchanger for transmitting heat between the refrigerant and the environment, is established as condenser/gas cooler or evaporator dependent on the operational mode of the refrigerant circuit. The second heat exchanger of the primary circuit, which corresponds to the heat exchanger for supplying heat from the air to be conditioned of the passenger compartment to the refrigerant, is provided as evaporator. The heat exchanger of the secondary branch serves as condenser/gas cooler and for afterheating the cooled air to be conditioned that is supplied to the passenger compartment.

According to an advantageous embodiment of the invention, an internal heat exchanger is displaced that is established integrated into an accumulator to advantageously utilize the available space. The accumulator functions to separate and collect liquid refrigerant and on the low pressure side is positioned in direction of the refrigerant flow between an entering point or tap and the internal heat exchanger.

The entering point of the second flow path can be established as passive three-way valve. The direction of flow of the refrigerant is passively switchable, whereby the side with the higher pressure is closed by the pressure differential present at the valve.

The second expansion member in the first flow path of the secondary branch is provided for generating a medium pressure in the refrigerant circuit. The flow cross-section of the second expansion member is advantageously designed controllable. The active control of the cross-section allows to avoid ice build-up of the evaporator and flash fogging as well, that is, the sudden fogging of the window glasses due to heating of the evaporator and the involved abrupt evaporating of the condensed water accumulated on the evaporator surface.

Further, the invention comprises an additional heat exchanger with an expansion member connected upstream integratable into the primary circuit. The additional heat exchanger with the associated expansion member is then switched parallel to the second heat exchanger.

According to another advantageous embodiment of the invention; the first and second heat exchangers of the primary circuit are integrated into intermediate circuits so that both the heat transmission on the high pressure side and the heat transmission on the low pressure side between the refrigerant and the heat carrier fluid each occur in the intermediate circuit.

The arrangement according to the invention of the components with the refrigerant circuit makes possible to switch between the heat pump and refrigeration plant operational mode of the refrigerant circuit of the HVAC system. In addition, the arrangement makes possible an advantageous afterheating operation.

In the process for operating the refrigerant circuit according to the invention of the HVAC system for combined refrigeration plant and heat pump operation and afterheating operation as well, during refrigeration plant operation the primary circuit and during heat pump operation and afterheating operation both the primary circuit and the secondary branch are passed by the refrigerant.

During heat pump operation and during afterheating operation, the second heat exchanger established as evaporator, the expansion member, the internal heat exchanger, and the first heat exchanger established as condenser/gas cooler as components of the primary circuit are passed in direction of flow opposite to the direction during refrigeration plant operation.

Through the control of the flow cross-section of the expansion member of the first flow path of the secondary branch, during afterheating operation the refrigerant-side pressure/temperature level in the evaporator of the primary circuit is advantageously controlled. Hereby the air to be conditioned of the passenger compartment is cooled and dehumidified and subsequently, heated in the condenser/gas cooler of the first flow path of the secondary branch.

According to the invention, with the control of the shut-off valve displaced between the tap of the first flow path and the tap of the second flow path in combination with a T-piece as tapping point and the expansion member of the first flow path, the mass flows of the refrigerant in the primary circuit and the first flow path of the secondary branch are dividable. Therefore, the respective capacities of the heat exchangers during afterheating operation, that is the heating output of the condenser/gas cooler of the secondary branch and the cooling output of the evaporator of the primary circuit are, particularly advantageously, controllable independently of each other.

Hereby the heating output depends on the temperature of the air to be conditioned and the mass flow of the refrigerant through the condenser/gas cooler, or the expansion member with its cross-section established controllable, thus on the refrigerant-side temperature level in the evaporator, and is controlled by means of the shut-off valve between the taps of the flow paths of the secondary branch.

A substantial advantage of the continuously operatable air-air heat pump, or the continuously operatable refrigerant circuit of the HVAC system with low complexity, respectively, additionally is the possibility of heating the passenger compartment during recirculating operation of the ventilation.

Optimized operation of the refrigerant circuit according to the invention of the HVAC system avoids a disadvantageous icing of the second heat exchanger in the primary circuit. Neither intermittent operation for avoiding icing of the gas cooler nor active defrosting are required.

Further advantages of the refrigerant circuit of the HVAC system over prior art can be summarized as follows:
fast supply of hot air at low ambient temperatures and cold cooling water of the engine cooling circuit when used in hybrid vehicles;
reduction of the power required for heating the passenger compartment and possible heating during recirculating operation of the ventilation;
high-efficient refrigeration plant operation through cooling the high pressure side refrigerant below ambient temperature due to specific air ducting without simultaneous heating of the suction gas, whereby the condenser/gas cooler, at least partly, i.e. in the area of the refrigerant-side exit of the condenser/gas cooler, is flowed over by recirculated air, or exit air from the cooled passenger compartment, respectively, with the refrigerant exit temperature thereby being cooled below the ambient air temperature;
good dynamic behaviour and low complexity compared to other auxiliary heating systems with comparable functionality;
afterheating operation with a lower heating power of the afterheater than the refrigerating power in the evaporator;
hermetic refrigerant circuit without dynamic seals, therefore, as arrangement within the compact HVAC system technically leakage-free fillable before being installed into the vehicle;
the low complexity and low number of active components result in cost saving during manufacture; and
the possibility of complete circuiting and testing of the HVAC system before mounting it into the vehicle results in fewer quality problems and reworking amount.

In one embodiment, a vehicle HVAC system comprises an evaporator unit including two air-passed heat exchangers and a fan disposed in a casing; a condenser unit including an air-passed heat exchanger and a fan disposed in a casing; a component unit housing a plurality of circuit components; and a refrigerant circuit, wherein the casings of the evaporator unit, the condenser unit, and the component unit establish an integrated, compact casing arrangement in which the refrigerant circuit is disposed, wherein the heat exchangers of the evaporator unit and the condenser unit are disposed within the casing arrangement and are in fluid communication with the refrigerant circuit.

In another embodiment, a vehicle HVAC system having a refrigerant circuit comprises a primary circuit with a compressor, a heat exchanger passable bidirectionally for heat transfer between a refrigerant and the environment, a first expansion member with two flow paths passable by the refrigerant in opposite directions, and a heat exchanger passable bidirectionally for a heat supply from air to be conditioned for a passenger compartment to the refrigerant; a secondary branch including a first flow path and a second flow path, the first flow path extending from a tap positioned between the compressor and the heat exchanger passable bidirectionally for heat transfer between the refrigerant and the environment to a tap positioned between the heat exchanger passable bidirectionally for the heat supply from the air to be conditioned for the passenger compartment to the refrigerant and the compressor, the first flow path provided with a heat exchanger for transferring heat from the refrigerant to the air to be conditioned for the passenger compartment and a second expansion member disposed downstream of the heat exchanger for transferring heat from the refrigerant to the air to be conditioned for the passenger compartment, the second flow path extending from a tap positioned between the compressor and the heat exchanger passable bidirectionally for heat transfer between the refrigerant and the environment to a tap positioned between the heat exchanger passable bidirectionally for the heat supply from the air to be conditioned for the passenger compartment to the refrigerant and the compressor; and a valve disposed between the tap positioned between the compressor and the heat exchanger passable bidirectionally for heat transfer between the refrigerant and the environment of the first flow path and the tap positioned between the compressor and the heat exchanger passable bidirectionally for heat transfer between the refrigerant and the environment of the second flow path, wherein the HVAC system is operable in a combined refrigeration plant mode and a heat pump mode, as well as an afterheating operation mode.

### BRIEF DESCRIPTION OF THE DRAWINGS

Further details, features and advantages of the invention will become apparent from the following description of examples of embodiment in connection with the accompanying drawings. It is shown by;

FIG. 1: compact vehicle HVAC system with linear arrangement of the flow channels.

FIG. 2: refrigerant circuit within the casing arrangement of the HVAC system with parallel arrangement of the flow channels.

FIG. 3: evaporator unit of the HVAC system with circuit components displaced therein.

FIG. 4: condenser unit of the HVAC system with circuit components displaced therein.

Component unit of the HVAC system with circuit components displaced therein:

FIG. 5a: without intermediate circuits;

FIG. 5b: with intermediate circuits,

Refrigerant circuit of the HVAC system:
in refrigeration plant operational mode

FIG. 6: with direct heat transmission between ambient air and refrigerant;

FIG. 7: with indirect heat transmission over intermediate circuits;

Alternatively in refrigeration plant or heat pump operational mode

FIG. 8: with actively controlled switching valve;

FIG. 9: with actively controlled switching valve and additional expansion valve;

alternatively in refrigeration plant, heat pump, or afterheating operational mode—with shut-off valve and additional expansion valve

FIG. 10a: refrigeration plant and heat pump operation;

FIG. 10b: afterheating operation, and

FIG. 11: as air-glycol heat pump.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

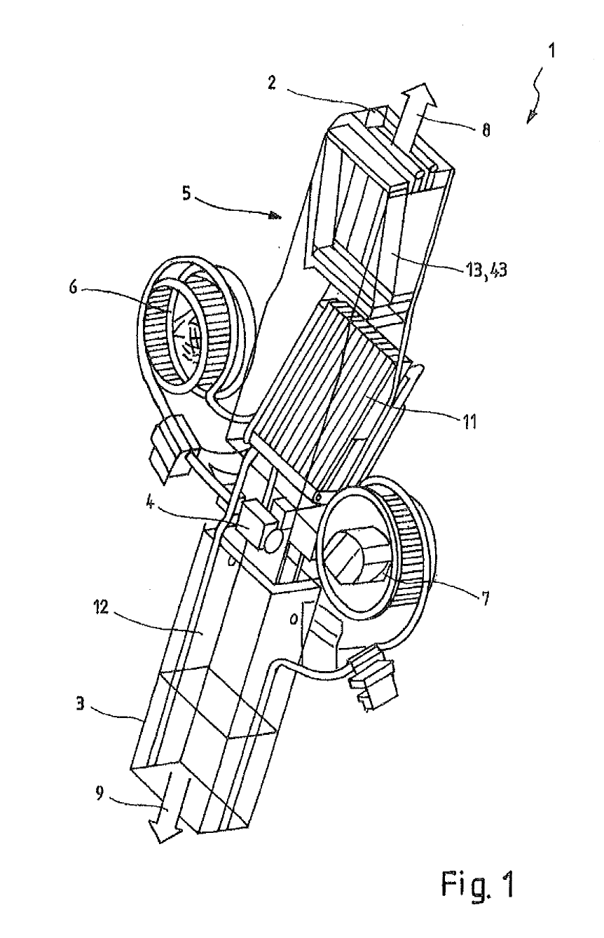

In FIG. 1, the compact vehicle HVAC system 1 according to the invention with a linear arrangement of the flow channels is shown. The casings of the evaporator unit 2 and the condenser unit 3, each forming a flow channel of a fresh/recirculated air system, have a rectangular flow cross-section in the range of the channels and are displaced with their faces to each other, linearly after each other. The faces displaced to each other are established closed, whereas the respective opposite sides, as sides of air exit, are established open. In an alternative arrangement, the casings of the evaporator unit 2 and the condenser unit 3 can also be oriented to each other at any angle.

Between the casings of the evaporator unit 2 and the condenser unit 3 the component unit 4 is displaced. The component unit 4, where all circuit components not flowed over by air are placed, is connected to the closed faces of the evaporator unit 2 and condenser unit 3 that form the air flow channels so that the evaporator unit 2, the condenser unit 3 and the component unit 4 together form a compact column-like casing arrangement.

For delivery of air through the evaporator unit 2 and the condenser unit 3 as fresh/recirculated air systems, fans 6, 7 are provided extending the column-like casing arrangement 5 in form of a cross, with the fans 6, 7 each positioned within the casings at the sides of the flow channels. The fans 6, 7 established as radial blowers draw in the air in axial direction, delivering the air then in direction of flow 8, 9 through the flow channels where the heat exchangers 11, 12, 13 passed by the air are displaced. The directions of the air flows are changed on passing the flow channels. The air flows radially exiting from the fans 6, 7 enter the flow channels, which are provided with the heat exchangers 11, 12, 13 that are passed by the air, at an angle between 90° and 110°. After entering, the air flows are redirected in the flow channel and exit in direction of flow 8, 9 from the flow channels of the casings of the evaporator unit 2 and condenser unit 3.

Both the evaporator heat exchanger 11 and the afterheater heat exchanger 13, 43 within the evaporator unit 2 and the condenser/gas cooler heat exchanger 12 within the condenser unit 3 are among the heat exchangers passed by the air. Hereby the afterheater 13, 43 can be established as condenser/gas cooler 13 or as heating heat exchanger 43.

The conditioned air leaves the evaporator unit 2 or the condenser unit 3 at the open faces of the casings. Each fan 6, 7, and therefore, each flow channel, can be supplied with fresh air from the environment, recirculated air from the passenger compartment, or a mixture of fresh and recirculated air. Further, the fans 6, 7 are speed-controlled so that each air flow through the casings can be varied.

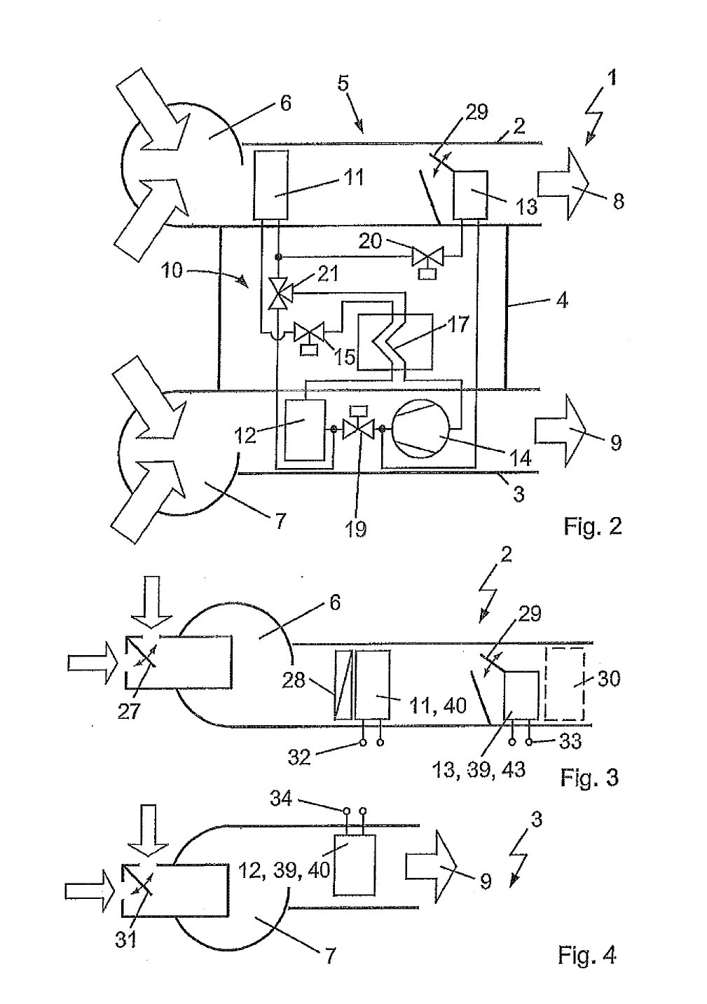

In FIG. 2, the refrigerant circuit 10 within the casing arrangement 5 of the vehicle HVAC system 1 is shown as an embodiment of the invention with parallel arrangement of the flow channels.

The air drawn in over the fan 6 of the evaporator unit 2 is, in direction of flow 8, first passed through the evaporator 11 of the refrigerant circuit 10 and cooled and dehumidified. The pre-conditioned air then flows either through the condenser/gas cooler 13 being heated, or by means of the temperature flap 29 guided passing the afterheater 13. Depending on the operational mode and desired state parameters of the air to be supplied to the passenger compartment, the temperature flap 29 is oriented in a different position. In pure cooling, or refrigeration plant operation, respectively, the air is guided passing the afterheater 13. The temperature flap 29 is placed in the flow channel in air flow direction, blocking the air duct section through the afterheater 13. If it is intended that the whole pre-conditioned air flow passes the afterheater 13, the temperature flap 29 bears against the upper edge of the flow channel. The position of the temperature flap 29 is continuously pivotable between the two positions mentioned.

The desired state parameters of the air to be supplied to the passenger compartment are, apart from adjusting the temperature flap 29 with the associated splitting of the air flow, also controllable by means of controlling the afterheating output of the afterheater 13 over the refrigerant mass flow, the high pressure, and/or final temperature of the compression, which can be done without using the temperature flap 29.

The component unit 4, which is displaced on the longitudinal sides of the evaporator unit 2 and the condenser unit 3, forming a compact casing arrangement 5 with both of them, includes the circuit components 15, 17, 20, 21 that are not flowed over by air.

The air drawn in over the fan 7 of the condenser unit 3 is, in direction of flow 9, first passed through the heat exchanger 12 of the refrigerant circuit 10 and heated or cooled depending on the operational mode. The compressor 14 is, in the embodiment of the vehicle HVAC system 1 of FIG. 2, displaced within the flow channel of the condenser unit 3. This displacement of the compressor 14 serves to cool and hence compress the refrigerant more efficiently. The compression final temperature of the refrigerant exiting from the compressor 14 and the energy consumption are lower compared to compression without additional cooling.

All circuit components 11, 12, 13, 14, 15, 17, 19, 20, 21 are displaced in one of the casings of the evaporator unit 2, the condenser unit 3 or the component unit 4 so that the entire refrigerant circuit 10 is enclosed by the compact casing arrangement 5.

FIG. 3 shows the evaporator unit 2 of the vehicle HVAC system 1 as single component of the casing arrangement 5, which is on assembly joinable with the other components of the system. The fan 6 draws the air over a fresh air/recirculated air flap 27. The air flows into the evaporator unit 2 either as fresh air, recirculated air, or a mixture of fresh and recirculated air. Using the fresh air/recirculated air flap 27, the mixing ratio of fresh air of the environment and recirculated air from the passenger compartment is adjusted, with any mixing ratio between 100% recirculated air and 100% fresh air being adjustable. The drawn in and mixed air is then passed through a filter 28 and cleaned before reaching the evaporator 11 of the refrigerant circuit 10 or the glycol heater 40. As already seen in FIG. 2, the pre-conditioned air is either passed through the afterheater 13 or guided passing the afterheater 13. Particularly, when the air flow is divided into a partial flow through the afterheater 13 and a partial flow bypassed around the afterheater 13, the partial flows are then remixed in the mixing chamber 30 in order to ensure a homogeneous temperature of the air flow before the air flow enters the passenger compartment. Dependent on the proportions of the air flows over the heat exchanger 13, 39, 43 or in bypass mode around the heat exchanger 13, 39, 43, the temperature of the air flow entering the passenger compartment is adjustable.

In hybrid vehicles, instead of the condenser/gas cooler 13 in the evaporator unit 2, also a glycol cooler 39, i.e. a glycol-air heat exchanger 39, or a heating heat exchanger 43 that transmits the heat from the engine cooling circuit to the air can be provided.

During assembly of the refrigerant circuit 10 or the vehicle HVAC system 1, respectively, the evaporator 11 and the afterheater 13 are connected to other circuit components over the connections 32, 33. If the heat exchanger for afterheating the air is established as glycol-air heat exchanger 39 or heating heat exchanger 43, the connection 33 corresponds to a connection of the respective system or circuit.

In FIG. 4, the condenser unit 3 of the vehicle HVAC system 1 is shown as single component of the casing arrangement 5, which on assembly is joinable to the other components of the system. The fan 7 draws the air over an exit air/fresh air flap 31. Using the exit air/fresh air flap 31, the mixing ratio of exit air from the passenger compartment and fresh air of the environment can be adjusted, with any mixing ratio between 100% exit air and 100% fresh air being adjustable. The drawn in and mixed air is then passed through the heat exchanger 12 of the refrigerant circuit 10. The heat exchanger 12, 39, 40 can be alternatively established as condenser/gas cooler 12, glycol cooler 39 or glycol heater 40 dependent on the design of the vehicle HVAC system 1.

During assembly of the refrigerant circuit 10 or the vehicle HVAC system 1, respectively, the heat exchanger 12 is connected to other circuit components over the connection 34. If the heat exchanger for afterheating the air is established as glycol-air heat exchanger 39, 40, the connection 34 corresponds to a connection of the glycol circuit.

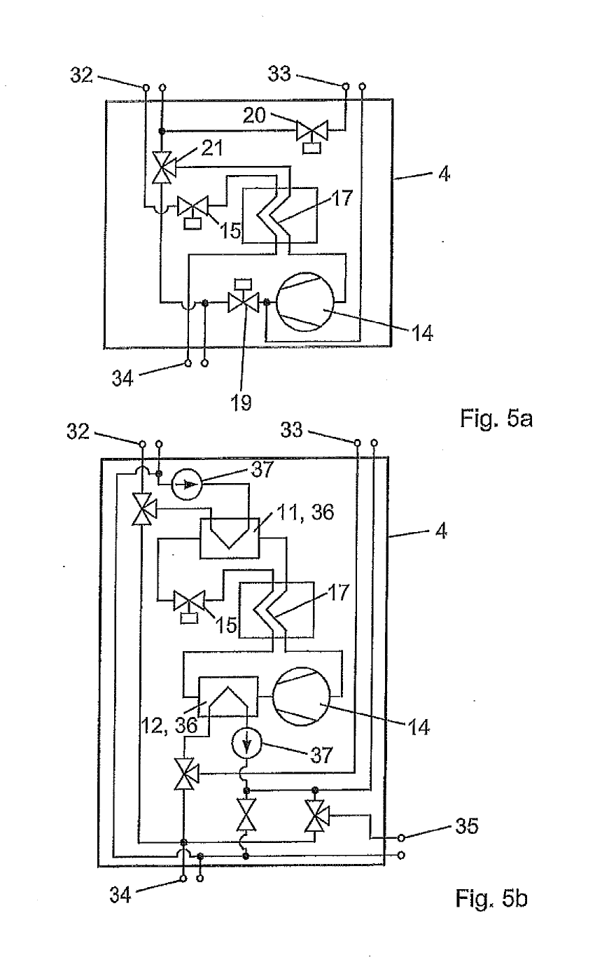

FIGS. 5a and 5b show the component unit 4 of the vehicle HVAC system 1 as single components of the casing arrangement 5 with the circuit components 14, 15, 17, 19, 20, 21 that are not flowed around by air, with and without an additional intermediate circuit. The refrigerant circuit 10 is pre-assembled within the component unit 4 and at points of transition to other components of the vehicle HVAC system 1 provided with connections 32, 33, 34. The circuit components of the component unit 4 are coupled to the evaporator 11 and the condenser/gas cooler 13 of the evaporator unit 2 over the connections 32, 33. The connection 34 serves for coupling to the heat exchanger 12 of the condenser unit 3.

Additionally, in contrast to FIG. 5a, in FIG. 5b intermediate circuits are shown. Here the heat exchangers 11, 12 are not passed by air, but are established as refrigerant-glycol heat exchangers 36. The heat is transmitted between the refrigerant and the intermediate circuits that on their part transmit the heat to the air or take the heat from the air. As heat carrier medium, glycol flows in the intermediate circuits. The flow is created using pumps 37 and guided using additional valves. The entire refrigerant circuit 10 and parts of the intermediate circuits are pre-assembled in the component unit 4. The refrigerant circuit 10 is closed, pre-assembled, and may already be filled.

The intermediate circuits of the component unit 4 are coupled to the glycol heater 40 and the glycol cooler 39 of the evaporator unit 2 over the connections 32, 33. The connection 34 serves for coupling to the glycol cooler 39 of the condenser unit 3. The connection 35 is an additional coupling spot to another glycol heat exchanger, which can, for example, be used for conditioning of different aggregates in the vehicle such as the drive battery.

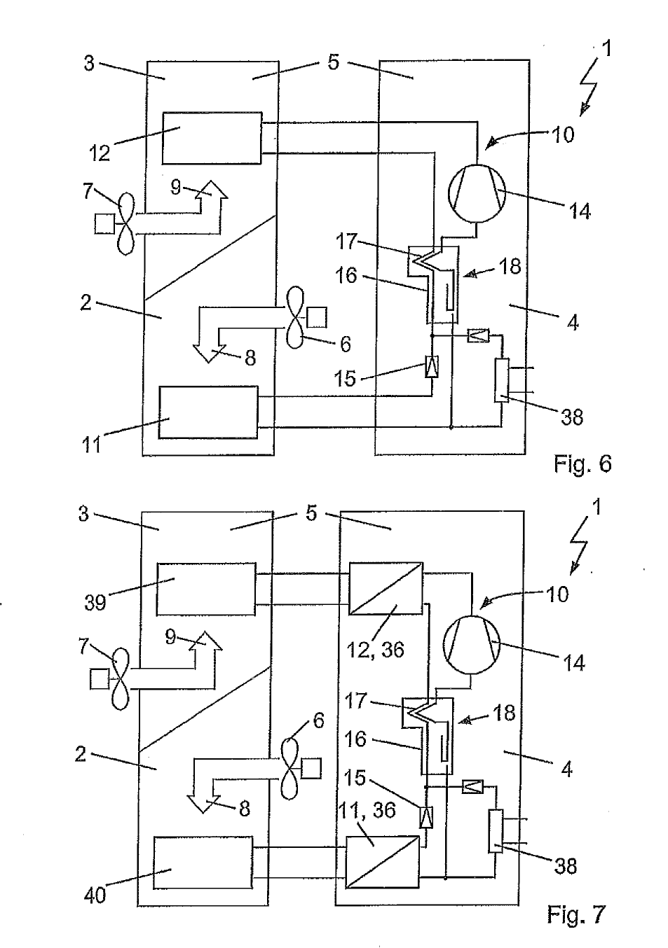

In FIG. 6, the refrigerant circuit 10 of the vehicle HVAC system 1, in particular as refrigeration plant, is shown with direct heat transmission between the ambient air and the refrigerant. This refrigerant circuit is a classical one with evaporator 11, compressor 14, condenser/gas cooler 12 and expansion valve 15. Within the classical refrigerant circuit, also known as primary circuit, an internal heat exchanger 17 is provided that serves to transfer heat between the liquid refrigerant at high pressure and the gaseous refrigerant at low pressure. On the one hand, the liquid refrigerant is further cooled after condensation and on the other hand, the suction gas overheated. Advantageously, the internal heat exchanger 17 is integrated into an accumulator 16, whereby the casing of the accumulator 16 completely encloses the internal heat exchanger 17 and is positioned at the low pressure side after the evaporator 11 in direction of flow.

When the refrigerant is liquified in subcritical operation, such as with the refrigerant R134a or under certain ambient conditions with carbon dioxide, the heat exchanger 12 is called condenser. The heat transmission partly occurs at constant temperature. In supercritical operation or when heat is supercritically delivered in the heat exchanger 12, the temperature of the refrigerant decreases continuously. In this case, the heat exchanger 12 is also called gas cooler. Supercritical operation can occur at certain ambient conditions or operational modes of the vehicle HVAC system 1 with carbon dioxide as the refrigerant.

Optionally, also an additional evaporator 38 as battery cooler, for example, can be integrated with the refrigerant circuit 10. The battery is, for example, coupled to the refrigerant circuit 10 over an intermediate circuit with glycol as the heat carrier medium. Instead of the drive battery, also other aggregates can be cooled using additional heat exchangers integrated into the refrigerant circuit 10.

The circuit components 14, 15, 16, 17, 18, 38, which are not flowed around by the air, are displaced in the component unit 4 of the casing arrangement 5 of the vehicle HVAC system 1. The circuit components which are flowed around by the air, namely the condenser/gas cooler 12 and the evaporator 11, are within the condenser unit 3 or the evaporator unit 2 that are passed by air in a certain direction of flow 8, 9. All circuit components 11, 12, 14, 15, 16, 17, 18, 38 of the closed refrigerant circuit 10 are thus advantageously integrated within the casing arrangement 5 of the vehicle HVAC system 1.

FIG. 7 shows the refrigerant circuit 10 of the vehicle HVAC system 1 in refrigeration plant operation with indirect heat transmission over intermediate circuits. Both the heat at the high pressure side and the heat at the low pressure side are transmitted from the refrigerant circuit 10 to an intermediate circuit each. At the high pressure side, the heat is delivered from the refrigerant to glycol in the condenser/gas cooler 12 that is, for example, established as refrigerant-glycol heat exchanger 36. At the low pressure side, the heat is taken by the refrigerant in the evaporator 11, a second refrigerant-glycol heat exchanger 36. The heat is taken by the air or delivered to the air via the heat carrier medium glycol that circulates in the intermediate circuits. Heat transmission between the ambient air and the heat carrier medium occurs in the glycol-air heat exchangers 39, 40, whereby the air is heated in the glycol cooler 39 and cooled in the glycol heater 40.

The refrigerant circuit 10 with indirect heat transmission over intermediate circuits has the advantage that the entire refrigerant circuit 10, that is all refrigerant-containing circuit components 11, 12, 14, 15, 16, 17, 18, 36, is Integratable in a very compact manner in the component unit 4 of the casing arrangement 5 and pre-assembled and filled in the component unit 4 is installable into the vehicle. The evaporator unit 2 and the condenser unit 3, which form the flow channels for the air, are displaceable in the vehicle independent of each other and the component unit 4. The vehicle manufacturer can assemble and fill the intermediate circuits during assembling the vehicle. For example, all connections 32, 33, 34, 35 between the evaporator unit 2, the condenser unit 3, and the component unit 4 can be designed as quick-connect couplings in order to simplify the assembly.

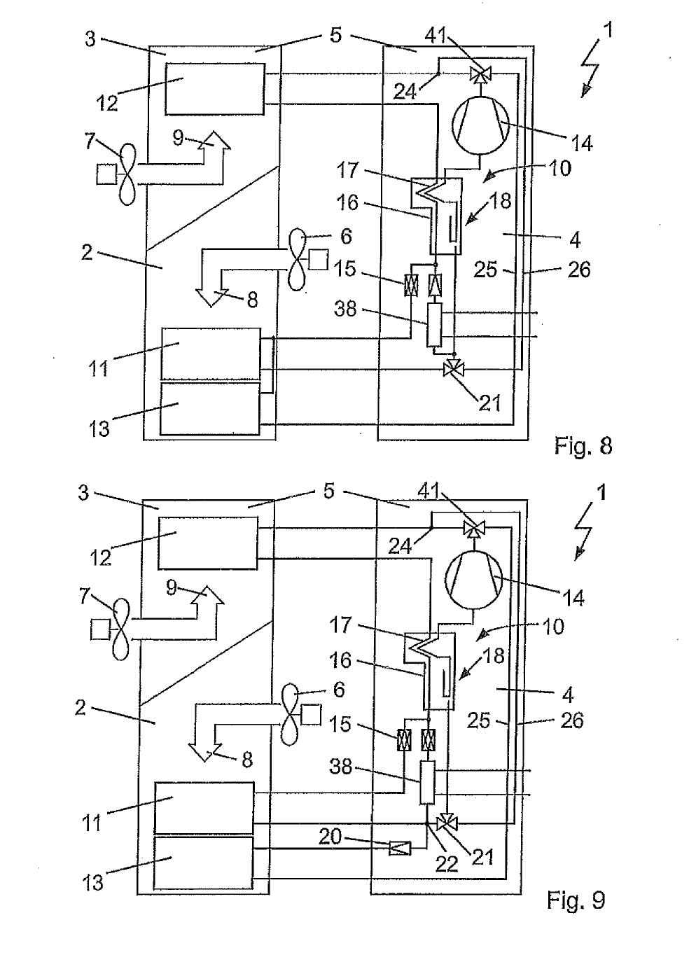

In FIG. 8, the refrigerant circuit 10 of the vehicle HVAC system 1 is shown in the alternative refrigeration plant or heat pump operational mode with the actively controlled switching valve 41. In contrast to the refrigerant circuits of the FIGS. 6 and 7, this refrigerant circuit 10, which apart from the primary circuit is provided with a secondary branch including two flow paths 25, 26 enables the vehicle HVAC system 1 to be alternatively operated also for heating or in the heat pump operational mode.

For heating using the refrigerant circuit 10, compared with the refrigerant circuit 10 of FIG. 6, an additional actively controlled switching valve 41, a second condenser/gas cooler 13 and a passive valve 21 are provided.

At low ambient temperatures the passenger compartment has to be heated, which can be done using the vehicle HVAC system 1 operated in heating or heat pump operational mode. In heat pump operational mode, the active switching valve 41 is controlled such that the refrigerant mass flow after the compressor 14 is led over the second condenser/gas cooler 13. In the condenser/gas cooler 13, heat is delivered from the refrigerant to the air supplied to the passenger compartment. Subsequently, the refrigerant is relieved in the expansion member 15, which is established as expansion valve, to a pressure level corresponding to the ambient temperature. In the condenser/gas cooler 12, the refrigerant takes heat from the environment. The refrigerant mass flow is then passed over the tap 24 and the passive valve 21 to the compressor 14, the refrigerant circuit 10 thus being closed. The passive valve 21 is designed such that the side where the higher pressure is applied is closed by the pressure differential present over the valve 21.

The refrigerant circuit 10 shown in FIG. 8 is disadvantageous in so far that heating and cooling operations cannot be performed at the same time. The air to be supplied to the passenger compartment and to be conditioned cannot be cooled and then immediately re-heated before being led to the passenger.

FIG. 9 shows the refrigerant circuit 10 of the vehicle HVAC system 1 in alternative refrigeration plant or heat pump operational mode with actively controlled switching valve 41 and, compared to the refrigerant circuit of FIG. 8, an additional expansion member 20 established as expansion valve. The expansion member 20 is in direction of flow positioned between the condenser/gas cooler 13 and a tap 22.

The disadvantage of the refrigerant circuit 10 shown in FIG. 8, namely no simultaneous cooling and heating of the air, can be countered using the additional expansion member 20. Use of the expansion member 20 in the heat pump operational mode makes the evaporator 11 controllable to a medium pressure level between the heat-delivering level in the second condenser/gas cooler 13 and the heat-taking level in the first condenser/gas cooler 12. If it is ensured that the air temperature before the evaporator 11 is higher than 10° C., the air passing over the evaporator 11 can be dehumidified without ice build-up at the heat transmission surface of the evaporator 11 and the dried air warmed or heated up in the second condenser/gas cooler 13.

Another advantage of the refrigerant circuit 10 according to FIG. 9 is that apart from the ambient air, also the latent heat of the passenger compartment air is additionally usable as heat source. The heat removed when the recirculating air is dehumidified, particularly during cooling or temperature change of the air flow, is to be re-fed to the air flow as sensible proportion in the second condenser/gas cooler 13. The latent proportion of the heat removed during dehumidification for condensating the humidity of the air that does not cause a temperature change of the air flow does not have to be re-fed to the air flow. Because this proportion of the heat removed from the recirculating air does not have to be afterheated, the latent heat is an additional heat supplied to the refrigerant circuit.

A disadvantage of the refrigerant circuit 10 to FIG. 9 in heat pump operational mode is that the heating output of the second condenser/gas cooler 13 is always higher than the refrigeration input taken by the evaporator 11. This disadvantage can be countered by a simple modification of the refrigerant circuitry.

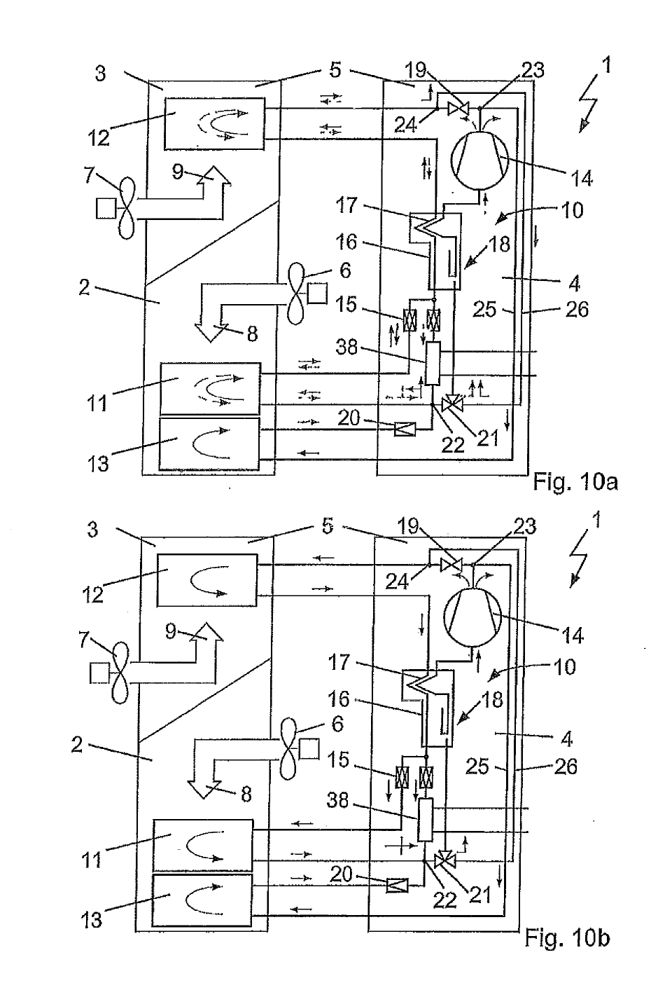

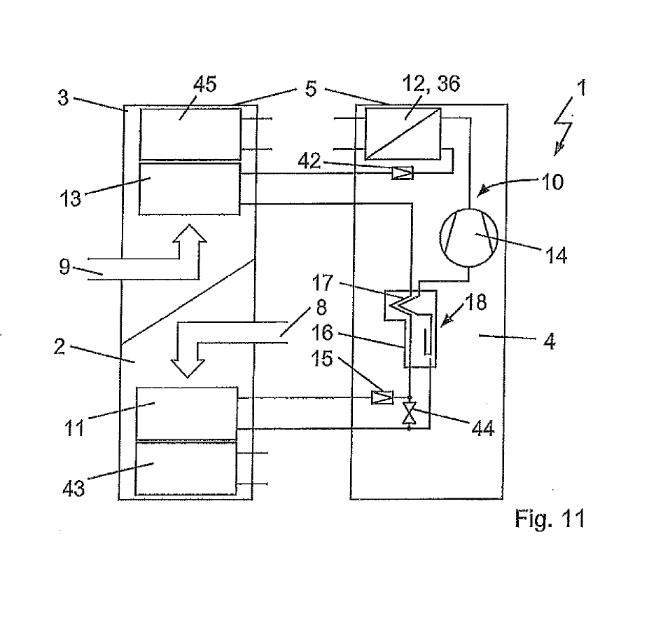

In FIGS. 10a, 10b the refrigerant circuit 10 according to the invention of the vehicle HVAC system 1 is represented alternatively in the refrigeration plant, heat pump, or afterheating operational mode with shut-off valve 19 and additional expansion valve 20, whereby FIG. 10a shows the refrigeration plant and heat pump operational mode and FIG. 10b shows the afterheating operational mode by means of arrows that show the direction of flow of the refrigerant. The dashed arrows in FIG. 10a show the direction of flow of the refrigerant in the refrigeration plant operational mode, the solid arrows the direction of flow of the refrigerant in the heat pump operational mode. The arrows in FIG. 10b show the direction of flow of the refrigerant in the afterheating operational mode.

The disadvantage of the refrigerant circuit 10 of FIG. 9, namely that the heating power of the second condenser/gas cooler 13 is always higher than the refrigeration power taken in the evaporator 11 is countered by an exchange of the active switching valve 41 with a shut-off valve 19 and an additional T-piece that defines a tap 23 between the compressor 14 and the shut-off valve 19. This arrangement within the refrigerant circuit 10 makes possible to control the heating power in the second condenser/gas cooler 13 independently of the refrigeration power in the evaporator 11.

In refrigeration plant operational mode, the shut-off valve 19 is opened, the expansion member 20 after the second condenser/gas cooler 13 closed. In heat pump operational mode, the shut-off valve 19 is closed, the expansion member 20 after the second condenser/gas cooler 13 opened. Both modes are marked with arrows in FIG. 10a.

The reheat, or afterheating operational mode, respectively, of the refrigerant circuit 10 of the vehicle HVAC system 1 is marked with the arrows in FIG. 10b. Here the expansion member 20 with the shut-off valve 19 opened is controlled such that a heating power at the second condenser/gas cooler 13 is provideable that can be lower than the refrigeration power at the evaporator 11.

During the refrigeration plant operational mode, the refrigerant is compressed in the compressor 14 before passing the opened shut-off valve 19, subsequently delivering heat to the ambient air in the condenser/gas cooler 12. The refrigerant cooled at high pressure subsequently flows through the high pressure part of the internal heat exchanger 17, there being cooled further. Then, the liquid refrigerant when passing the expansion member 15 is released to the pressure level governing in the evaporator 11 into the dual-phase region. The dual-phase mixture is evaporated in the evaporator 11. The heat required for that is taken from the ambient air which in cooled condition is supplied to the passenger compartment. Then, the refrigerant passes the passive valve 21. The passive valve 21 has two inlets and one exit, established such that in each case, the inlet where the higher pressure exists is closed by the pressure forces and the refrigerant mass flow is passed from the inlet where the lower pressure exists to the exit. In the accumulator 16, the refrigerant liquid still present due to incomplete evaporation is separated and stored. After then, the refrigerant overheated in the low pressure part of the internal heat exchanger 17 is drawn in by the compressor 14 and compressed anew. The refrigerant circuit 10 is closed. At high ambient temperatures, the expansion member 20 is closed so that no refrigerant is passed over the second condenser/gas cooler 13, hence no heating power provided. After the passenger compartment has been cooled down, the shut-off valve 19 is opened and a refrigerant partial mass flow specifically is passed over the second condenser/gas cooler 13. Hereby the required reheat or afterheating power is provided.

Optionally, in the refrigerant circuit 10, further heat exchangers 38, for example for cooling electric aggregates such as battery, electromotor, power electronics or the like, are usable. For each additional heat exchanger 38, an additional expansion member has to be provided.

At low ambient temperatures, the refrigerant circuit 10 of the vehicle HVAC system 1 is operated as heat pump. The refrigerant is compressed in the compressor 14. The shut-off valve 19 is closed so that the refrigerant completely passes the second condenser/gas cooler 13 delivering heat to the air to be supplied to the passenger compartment. In the expansion member 20, the cooled refrigerant is then relieved to a medium pressure level. With help of the medium pressure level, the refrigerant-side temperature level in the evaporator 11 is controlled, whereby the temperature level in the evaporator 11 should not be reduced below 0° C., when the temperature of the air before the evaporator 11 is above 0° C. In this case, the danger of ice build-up of the evaporator 11 rises. On the other hand, the temperature level in the evaporator 11 should not be above 0° C., when the temperature of the air before the evaporator 11 is below 0° C. In this case, there is the above mentioned danger of flash fogging. After the expansion in the expansion member 20, the refrigerant exists as dual-phase mixture. The liquid is then at least partly evaporated in the evaporator 11, whereby the air supplied to the passenger compartment is dehumidified. The dehumidified air then passes the second condenser/gas cooler 13, thereby being heated to a temperature level necessary for heating the passenger compartment. After evaporation in the expansion member 15, the refrigerant is relieved to the pressure level prevailing in the condenser/gas cooler 12. In the condenser/gas cooler 12, the refrigerant is further relieved and supplied to the accumulator 16 over the passive switching valve 21.

The FIGS. 8 to 10 show not only the different refrigerant circuits 10, but also the arrangement of the components being parts of the refrigerant circuit 10 within the vehicle HVAC system 1. Hereby in each case, the circuit components 14, 15, 16, 17, 18, 19, 20, 21, 38 not flowed around by the air and the connection lines thereof are displaced in the component unit 4 of the casing arrangement 5 of the compact vehicle HVAC system 1. The circuit components flowed around by the air, namely evaporator 11 and condenser/gas cooler 13, are in the interior of the evaporator unit 2, the condenser/gas cooler 12 flowed around by the air in the interior of the condenser unit 3.

In FIG. 11, the refrigerant circuit 10 of the vehicle HVAC system 1 is shown as glycol heat pump. The design of the refrigerant circuit 10 makes possible in the heat pump operational mode to take heat from the environment and in the heat exchanger 12, 36 deliver it to an intermediate circuit. Also, waste heat of other aggregates can advantageously be fed into this intermediate circuit. After exiting from the heat exchanger 12, 36, the refrigerant is relieved in the expansion member 42. The heat exchanger 12, 36 is depending on the operational mode of the vehicle HVAC system 1 circuited either in the heat pump or heating operational mode with the glycol-air heat exchanger 43 or in the cooling, or refrigeration plant, operational mode with the glycol-air heat exchanger 45. The switching valves and pumps of the intermediate circuit are not shown.

In the heat pump operational mode, the temperature level of the evaporator 11 is always lower than the temperature level of the environment. Therefore heating of the passenger compartment in recirculated air operation with corresponding dehumidification is only possible at ambient temperatures above 0° C. At ambient temperatures below 0° C. the evaporator 11 is to be operated in bypass mode over the shut-off valve 44 in order to avoid icing of the evaporator 11, and hence, not to obstruct the air supply to the passenger compartment. For cooling of other aggregates, such as the drive battery in an electrovehicle, instead of the shut-off valve 44 a heat exchanger and an expansion valve have to be provided.

From the foregoing description, one ordinarily skilled in the art can easily ascertain the essential characteristics of this invention and, without departing from the spirit and scope thereof, make various changes and modifications to the invention to adapt it to various usages and conditions.

### NOMENCLATURE

1 HVAC system
2 evaporator unit
3 condenser unit
4 component unit
5 casing arrangement
6 fan evaporator unit
7 fan condenser unit
8 direction of flow of the air, evaporator unit
9 direction of flow of the air, condenser unit
10 refrigerant circuit
11 heat exchanger, evaporator, circuit component
12 heat exchanger, condenser/gas cooler, circuit component
13 heat exchanger, afterheater, condenser/gas cooler, circuit component
14 compressor, refrigerant circuit component
15 first expansion member, expansion valve, circuit component
16 accumulator, circuit component
17 internal heat exchanger, circuit component
18 accumulator-heat exchanger-unit, circuit component
19 valve, shut-off valve, circuit component
20 second expansion member, expansion valve, circuit component
21 entering point/tap, passive switching valve, passive three-way valve, circuit component
22 entering point/tap
23 tap
24 tap
25 first flow path secondary branch
26 second flow path secondary branch
27 recirculated-/fresh air flap
28 filter
29 temperature flap
30 mixing chamber
31 exit air/fresh air flap
32 connection evaporator
33 connection condenser/gas cooler
34 connection condenser/gas cooler
35 connection battery cooler
36 refrigerant-glycol heat exchanger, circuit component
37 pump
38 heat exchanger, evaporator, circuit component
39 glycol-air heat exchanger, glycol cooler, afterheater
40 glycol-air heat exchanger, glycol heater
41 controlled switching valve, circuit component
42 expansion member, circuit component
43 heating heat exchanger, afterheater
44 shut-off valve, circuit component
45 glycol-air heat exchanger

What is claimed is:

1. A vehicle HVAC system comprising:
an evaporator unit including two air-passed heat exchangers and a fan disposed in a casing;
a condenser unit including an air-passed heat exchanger and a fan disposed in a casing;
a component unit housing a plurality of circuit components; and
a refrigerant circuit, wherein the casings of the evaporator unit, the condenser unit, and the component unit establish an integrated, compact casing arrangement in which the refrigerant circuit is disposed, wherein the heat exchangers of the evaporator unit and the condenser unit are disposed within the casing arrangement and are in fluid communication with the refrigerant circuit.

2. The vehicle HVAC system according to claim 1, wherein the evaporator unit, the condenser unit, and the component unit are single units, joined to form the casing arrangement.

3. The vehicle HVAC system according to claim 1, wherein the component unit is disposed between the evaporator unit and the condensor unit.

4. The vehicle HVAC system according to claim 1, wherein the evaporator unit and the condenser unit each include a flow channel for air, wherein each of the flow channels is supplied with at least one of fresh air from the environment, recirculated air from the passenger compartment, and a mixture of fresh air and recirculated air from the passenger compartment.

5. The vehicle HVAC system according to claim 4, wherein a compressor of the refrigerant circuit is disposed in the flow channel of the condenser unit.

6. The vehicle HVAC system according to claim 4, wherein the flow channels of the evaporator unit and the condenser unit are positioned such that a direction of flow of air leaving the evaporator unit and a direction of a flow of air leaving the condenser unit are oriented parallel to each other.

7. The vehicle HVAC system according to claim 4, wherein the flow channels of the evaporator unit and the condenser unit are positioned such that a direction of flow of air leaving the evaporator unit and a direction of a flow of air leaving the condenser unit are oriented opposite to each other along a common axis.

8. The vehicle HVAC system according to claim 1, wherein the fans of the evaporator unit and the condenser unit are respectively disposed laterally next to the flow channels of the evaporator unit and the condenser unit.

9. The vehicle HVAC system according to claim 1, wherein the fans of the evaporator unit and the condenser unit are disposed at opposite sides of the casing arrangement.

10. The vehicle system according to claim 1, wherein the casing arrangement forms a shape of a cross.

11. The vehicle HVAC system according to claim 1, wherein the refrigerant circuit includes an electrically driven compressor.

12. The vehicle HVAC system according to claim 1, wherein each of the evaporator unit and the condenser unit have a rectangular cross-sectional shape.

13. The vehicle HVAC system according to claim 1, wherein each of the evaporator unit and the condensor unit have an open side and a closed side, wherein the component unit is coupled to the closed side of each of the evaporator unit and the condensor unit.

14. The vehicle HVAC system according to claim 1, wherein one of the two air-passed heat exchangers of the evaporator unit is one of an evaporator and a glycol heater and an other of the two air-passed heat exchangers of the evaporator unit is one of a condenser, a glycol cooler, and a glycol heater.

15. The vehicle HVAC system according to claim 1, wherein the refrigerant circuit is in heat exchange communication with two intermediate circuits and the two intermediate circuits are in fluid communication with the two air-passed heat exchangers of the evaporator and the air-passed heat exchanger of the condenser unit.

16. A vehicle HVAC system comprising:
an evaporator unit including two air-passed heat exchangers and a fan disposed in a casing;
a condenser unit including an air-passed heat exchanger and a fan disposed in a casing;
a component unit housing a plurality of circuit components; and
a refrigerant circuit, wherein the casings of the evaporator unit, the condenser unit, and the component unit establish an integrated, compact casing arrangement in which the refrigerant circuit is disposed, wherein the heat exchangers of the evaporator unit and the condenser unit are disposed within the casing arrangement and are in fluid communication with the refrigerant circuit, and wherein the evaporator unit, the condenser unit, and the component unit are single units, joined to form the casing arrangement.

17. The vehicle HVAC system according to claim 16, wherein each of the evaporator unit and the condensor unit have an open side and a closed side, wherein the component unit is disposed between the evaporator unit and the condensor unit and coupled to the closed side of each of the evaporator unit and the condensor unit.

18. The vehicle HVAC system according to claim 16, wherein the evaporator unit and the condenser unit each include a flow channel for air, wherein each of the flow channels is supplied with at least one of fresh air from the environment, recirculated air from the passenger compartment, and a mixture of fresh air and recirculated air from the passenger compartment, wherein the flow channels of the evaporator unit and the condenser unit are positioned such that a direction of flow of air leaving the evaporator unit and a direction of a flow of air leaving the condenser unit are oriented opposite to each other along a common axis

19. The vehicle HVAC system according to claim 16, wherein the fans of the evaporator unit and the condenser unit are respectively disposed laterally next to the flow channels of the evaporator unit and the condenser unit.

20. A vehicle HVAC system comprising:
an evaporator unit including two air-passed heat exchangers disposed in a casing, a fan disposed in the casing, and a flow channel for air formed by the casing;
a condenser unit including an air-passed heat exchange disposed in a casing, a fan disposed in the casing, and a flow channel for air formed by the casing, wherein the flow channels of the evaporator unit and the condenser unit are positioned such that a direction of flow of air leaving the evaporator unit and a direction of a flow of air leaving the condenser unit are oriented opposite to each other along a common axis;
a component unit housing a plurality of circuit components; and
a refrigerant circuit, wherein the casings of the evaporator unit, the condenser unit, and the component unit establish an integrated, compact casing arrangement in which the refrigerant circuit is disposed, wherein the heat exchangers of the evaporator unit and the condenser unit are disposed within the casing arrangement and are in fluid communication with the refrigerant circuit
